(19) United States
(12) Patent Application Publication
(10) Pub. No.: US 2012/0042018 A1
(43) Pub. Date: Feb. 16, 2012

(54) SYSTEM AND METHOD FOR MESSAGE DELIVERY

(76) Inventors: Ravi Singh, Mississauga (CA); Neil Patrick Adams, Waterloo (CA); Shivangi Anantrupa Gandhi, Mississauga (CA)

(21) Appl. No.: 12/855,294

(22) Filed: Aug. 12, 2010

(51) Int. Cl. G06F 15/16

(52) U.S. Cl. 709/206

(57) ABSTRACT

A method of receiving an email message using a communication network is presented. The method includes identifying an email message to be retrieved from a server. The email message is a multi-part message and includes content having two or more content types. The method includes determining a first content type to be retrieved from the server. The first content type includes non-plain-text content. The method includes retrieving content of the email message having the first content type from the server using the communication network, presenting the content having the first content type, and, after retrieving the content having the first content type from the server, retrieving content of the email message having a second content type from the server. The method includes verifying a digital signature associated with the email message.

### BACKGROUND

The present disclosure relates generally to systems and methods for data communication and, more particularly, to a system and method for delivering encoded message or email data to a user equipment (UE).

As used herein, the terms “user equipment” and “UE” can refer to devices such as mobile telephones, personal digital assistants (PDAs), handheld, desk phones, netbooks or laptop/tablet computers, and similar devices that may include or execute various User Agents (“UAs”). In some embodiments, UE may refer to a mobile, wireless device. UE may also refer to devices that have similar capabilities but that are not generally transportable, such as desktop computers, set-top boxes, or network nodes.

In some cases, UEs communicate with a communications network using radio frequency (RF) communications. Communications networks may include different types of networks including (1) data-centric wireless networks, (2) voice-centric wireless networks, and (3) dual-mode networks that can support both voice and data communications over the same physical base stations, access devices, or other network components. Combined dual-mode networks include, but are not limited to, (1) Code Division Multiple Access (CDMA) networks, (2) Global System for Mobile Communication (GSM) networks and General Packet Radio Service (GPRS) networks, and (3) third-generation (3G) networks like Enhanced Data-rates for Global Evolution (EDGE) and Universal Mobile Telecommunications Systems (UMTS).

In many cases, using the communications network, a UE can communicate with other electronic devices via the Internet or local area networks (LANs). The UE can create/generate and consume data (e.g., non-voice) content by browsing web pages, sending or receiving email, and the like. Although the UE is not connected directly to the Internet for sending and receiving email, the communication network acts as a proxy to carry communications back and forth between the UE and other electronic devices (e.g., an Application Server, a Service Provider server, etc.) via the Internet.

Making use of modern communication networks, email is a versatile medium for communication. Commonly, emails include plain text—strings of characters that communicate a message. In some email programs, however, a user can modify the look of the text within an email, possibly by modifying various attributes of the text including font, color and/or size. In that case, the text contained within the email is ‘marked-up’.

When an email contains marked-up text, in addition to the characters making up the message, additional, hidden, characters or strings (e.g., metadata) are included or encoded within the contents of the email message. The hidden characters provide the email recipient's email client with information which may be employed to correctly display the text as originally intended by the email's sender.

One example of such a mark-up language is hyper-text markup language (HTML). Using HTML, hidden tags are inserted into the email message for controlling how the text of the message is to be displayed by the recipient's email software. For example, Table 1 shows a string of text including an encoded HTML tag. In the example, an underline tag has been included so that when displayed on by the recipient's email reader, the sentence actually looks like that shown in Table 2.

TABLE 1

This is a string of <u>text</u>.

TABLE 2

This is a string of text.

In addition to controlling the way that text is displayed, HTML can be used to modify the layout of text—for example, by placing the text into distinct columns or fields/boxes and inserting links to media such as images, sounds, or video into the email message. Although HTML is a popular markup language, it is just an example as many different types of markup languages can be used to modify the appearance of the content of an email.

Sometimes an email reader is unable to read or correctly display marked-up text included within an email message. For example, when an email reader/application/client is not HTML-capable it may not render HTML correctly such that the HTML tags which should be hidden may be displayed in-line with the email contents. This rendering of HTML tags makes the text difficult to read.

To mitigate the problems associated with email readers that cannot display marked-up text, email messages often include both a plain text and marked-up version of the same message. These are referred to as multi-part email messages as they contain several parts, with each part having a different encoding. If the recipient's email software cannot display the marked-up version of a multi-part email message, the plain text portion of the multi-part message can be displayed in its place. By including two versions of the content within the email, there is little risk that a user will be unable to read the email.

Multipart email messages can be constructed using Multipurpose Internet Mail Extensions (MIME). MIME allows for the inclusion of many different types of content in a multi-part email message, including, for example, plain text, HTML marked-up text, non-American Standard Code for Information Interchange (ASCII) characters, multiple message bodies, and attachments such as images, audio, video and applications. In some cases, when a message includes multiple content-types, MIME-types are used to indicate alternative content. For example, the multipart/alternative content type can be used to specify that the plain text content and HTML-encoded content of an email are to be used as alternative ways of displaying the email message. Generally, in a multi-part email message, the plain text content is placed before other, marked-up content.

Table 3 shows example content of a multi-part email message including both plain text and HTML MIME types. As shown in Table 3, the starting point of the plain text within the email is identified by the “Content-Type: text/plain” tag. Upon receiving the email message, the recipient's email software can use the “Content-Type: text/plain” tag to identify the plain text portion of the email for display to the user.

If, however, the user wishes to view (or the user's software is configured to display) the HTML marked-up portion of the email, the user's email program searches for the “Content-Type: text/html” tag that identifies the marked-up portion of the email. The software can then display the marked-up portion of the email message. As can be seen in Table 3, the marked-up portion of the email includes an HTML tag that modifies how the text of the email will be displayed.

TABLE 3
Date: Tue, 01 Jul 2003 09:48:30 -0700
MIME-Version: 1.0
Message-ID: <2.4.1057078110032@localhost>
Content-Transfer-Encoding: quoted-printable
Content-Type: multipart/mixed; charset=us-ascii;

boundary= BoUnDaRy_1057078110032.797.291273273055

From: sender@domain.com
To: recipient@domain.com
Subject: multipart mixed email.
-- Boundary_1057078110032.797.291273273055
Content-Type: multipart/alternative;

boundary= Boundary_1057078110032.355.65337159541633

-- Boundary_1057078110032.355.65337159541633
Content-Type: text/plain
This is plain text
-- Boundary_1057078110032.355.65337159541633
Content-Type: text/html
<b>This is HTML text</b>
-- Boundary_1057078110032.355.65337159541633--
-- Boundary_1057078110032.797.291273273055--

In some cases, rather than send and receive email directly (e.g., by communicating directly with email servers via the Internet), the UE is configured to communicate via a communication network with a server that is connected to the communication network. The server then, on behalf of the UE, communicates via the Internet with other email servers to send and receive emails on behalf of the UE. When the server receives an email on behalf of the user, the server forwards the email message to the user's UE via the communication network such that the email message can be displayed to or otherwise consumed by the user.

Sometimes, when an email includes both plain text and HTML-encoded portions, only the HTML-encoded portion of an email is transmitted to a UE over the communication network, assuming the UE has the capabilities to display the HTML-encoded portion. This allows the UE to display the content of the email message to a user while simultaneously minimizing an amount of consumed bandwidth on the communication network. By transmitting only the HTML-encoded portion, the plain text portion (which the UE would have ignored anyway) is not transmitted. Unfortunately, because the UE receives only a portion of the email, the UE is unable to verify any digital signature included within the email.

Several technologies such as Secure/Multipurpose Internet Mail Extensions (S/MIME) and Pretty Good Privacy (PGP) allow a sender to digitally sign an email message. The digital signature can be used to verify that the sender of the email was, in fact, the individual named in the “From:” line of the email message, for example. Signatures can also be used to verify the integrity of an email to ensure that the email's contents have not been modified since the email was originally sent.

To sign an email, the contents of the email (including both the plain text and any HTML-encoded portion), in combination with the sender's private cryptographic key are passed through a hash function (e.g., one-way hash). The function is a mathematical algorithm that uses both the contents of the email message and the sender's private key to generate a signature block (usually a string of hex digits). The signature block can then be included within the contents of the email message for later use, retrieval and authentication by the email's recipient, or others.

Upon receiving the signed email message, the recipient's email application or client on the UE retrieves the signature block from the contents of the email message and, using the sender's public key in combination with the contents of the email message itself, uses another mathematical function to verify that the message has not been altered and that it was actually signed by the purported signer (usually the sender of the email). If the signature block is verified, the email software can notify the user that the email message was successfully authenticated.

Because the signature block was originally generated using all the email content, to successfully verify the authenticity of a signature included in an email message, a UE should have access to all of the content of the email message including both plain text and marked-up portions. As such, when forwarding a signed, multi-part email message to a UE over a communication network, a server cannot send only the marked-up portion of an email message to minimize bandwidth consumption, as described above, because signature verification will fail. As such, the previously mentioned advantages of sending only the marked-up portion of the email message are unavailable when forwarding signed email messages.

In many existing networks, when forwarding an email to a UE, the server initially sends a first portion of the email message (typically just the portion of the email containing plain-text). The plain text portion, however, is usually not sufficient for the UE to verify the email's signature (if the email also includes marked-up text), but is enough for the UE to display the plain text portion of the email. As the UE requests additional portions of the email message from the server, however, the server transmits the next chunks of the email message to the UE which will, eventually, contain any marked-up text included within the email message. Eventually, the entire contents of the email message are transferred to the UE and the UE can verify the signature included in the email message.

This implementation, however, does not allow for efficient display of marked-up email content on the UE for signed messages. To display the marked-up portion of the email message, the UE must first wait to receive the plain text portion of the message before the UE can even begin receiving the marked-up portion of the message. It is only after the UE begins receiving the marked-up portion of the message that the UE can display any of the marked-up portions of the email message to a user. Accordingly, after requesting an email from the server, the UE may have to wait some time before the UE receives any useful data from the server for displaying the marked-up contents of an email message.

As such, methods, apparatuses (e.g., UE and server) and systems for efficiently communicating the contents of an email message would be welcome improvements in the art wherein the UE is able to: verify the authenticity of a digital signature encoded within the email message; and quickly display or present an HTML-encoded portion of the email to a user.

### BRIEF DESCRIPTION OF THE DRAWINGS

FIG. 1 is an illustration of an exemplary network configured to allow a user equipment (UE) to efficiently receive and display the contents of email messages in accordance with the present disclosure;

FIG. 2 is an illustration of an example method for a UE to efficiently receive content of an email from an email server, while also being able to verify a digital signature encoded within that email;

FIG. 3 is an illustration of an alternative example method for an email server to efficiently deliver content of an email to a UE, while also allowing the UE to verify a digital signature encoded within that email;

FIG. 4 is a diagram of a communications system including a UE operable for some of the various embodiments of the disclosure;

FIG. 5 is a block diagram of a UE operable for some of the various embodiments of the disclosure;

FIG. 6 is a diagram of a software environment that may be implemented on a UE operable for some of the various embodiments of the disclosure; and

FIG. 7 is an illustrative computer apparatus or system suitable for some of the various embodiments of the disclosure.

### DETAILED DESCRIPTION

The present disclosure relates generally to systems and methods for data communication and, more particularly, to a system and method for delivering encoded message or email data to a user equipment (UE).

In one embodiment, the present invention is a method of receiving an email message using a communication network. The method includes identifying an email message to be retrieved from a server. The email message is a multi-part message and includes content having two or more content types. The method includes determining a first content type to be retrieved from the server. The first content type includes non-plain-text content. The method includes retrieving content of the email message having the first content type from the server using the communication network, presenting the content having the first content type, and, after retrieving the content having the first content type from the server, retrieving content of the email message having a second content type from the server. The method includes verifying a digital signature associated with the email message.

In other implementations, the present invention is a method for transmitting an email message using a communication network. The method includes identifying an email message to be transmitted to a user equipment. The email message includes content having two or more content types. The method includes determining whether the user equipment is configured to display a first content type, and, when the user equipment is configured to display the first content type transmitting content of the email message having the first content type to the user equipment, and, after transmitting the content of the email message having the first content type to the user equipment, transmitting content of the email message having a second content type to the user equipment.

In other implementations, the present invention is a user equipment for receiving an email message using a communication network comprising a processor configured to identify an email message to be retrieved from a server. The email message is a multi-part message and includes content having two or more content types. The processor is configured to determine a first content type to be retrieved from the server, the first content type including non-plain-text content, retrieve content of the email message having the first content type from the server using the communication network, and present the content having the first content type. The processor is configured to, after retrieving the content having the first content type from the server, retrieve content of the email message having a second content type from the server, and verify a digital signature associated with the email message.

In other implementations, the present invention is a network component for transmitting an email message using a communication network comprising a processor configured to identify an email message to be transmitted to a user equipment. The email message includes content having two or more content types. The processor is configured to determine whether the user equipment is configured to display a first content type, and, when the user equipment is configured to display the first content type transmit content of the email message having the first content type to the user equipment, and, after transmitting the content of the email message having the first content type to the user equipment, transmit content of the email message having a second content type to the user equipment.

To the accomplishment of the foregoing and related ends, embodiments of the invention, then, comprise the features hereinafter as described. The following description and the annexed drawings set forth in detail certain illustrative aspects of the invention. However, these aspects are indicative of but a few of the various ways in which the principles of the invention can be implemented or employed.

The various aspects of the embodiments are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

As used herein, the terms “component,” “system” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The word “exemplary” is used herein to mean serving as an example, instance, or illustration. Any aspect or design described herein as “exemplary” is not necessarily to be construed as preferred or advantageous over other aspects or designs.

Furthermore, the disclosed subject matter may be implemented as a system, method, apparatus, or article of manufacture using standard programming and/or engineering techniques to produce software, firmware, hardware, or any combination thereof to control a computer or processor based device to implement aspects detailed herein. The term “article of manufacture” (or alternatively, “computer program product”) as used herein is intended to encompass a computer program accessible from any computer-readable device, carrier, or media. For example, computer readable media can include but are not limited to tangible or non-transitory apparatuses including magnetic storage devices (e.g., hard disk, floppy disk, magnetic tape, etc.), optical disks (e.g., compact disc (CD), digital versatile disk (DVD), etc.), smart cards, and flash memory devices (e.g., card, stick). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

The present system and method provides a mechanism for transmitting an email message to a UE. The system and method allows for the UE to both quickly display a marked-up or encoded portion of the email for a user, while also allowing the UE to verify a digital signature encoded within the email.

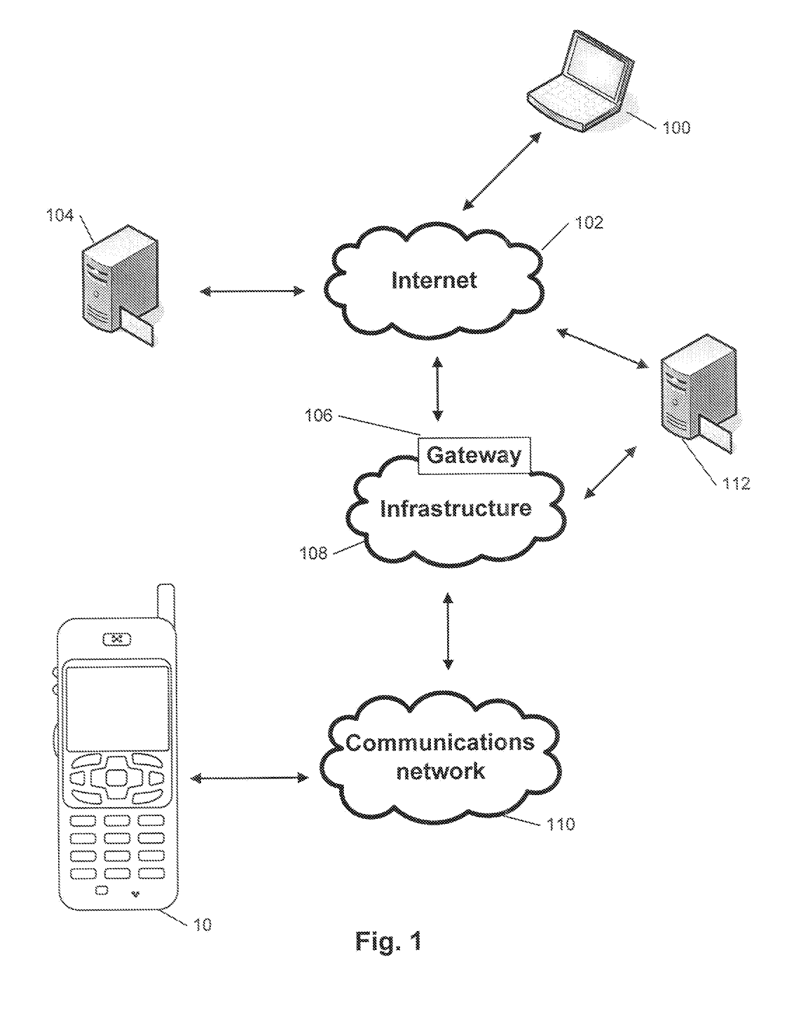

FIG. 1 is an illustration of an exemplary network configured to allow a UE to receive and display the contents of email messages in accordance with the present disclosure. Using the system, the UE is also able to display, for example, an HTML-encoded portion of an email and later verify a digital signature included within the email message.

FIG. 1 depicts client computer 100 configured to send and receive emails. Client computer 100 communicates via Internet 102 and, in the example shown in FIG. 1, is configured to send emails to email server 104. Email server 104 hosts an email account belonging to or associated with the user of UE 10.

Gateway 106 and infrastructure 108 provide a link between Internet 102 and communication network 110. Communication network 110 may include a wireless communications network, or other communications network using which the UE may communicate and is implemented by a collection of network components. Communications network infrastructure 108 is configured to act as a proxy between UE 10 and Internet 102 and provides the functionality for monitoring and locating a UE to, for example, allow roaming of the UE between different communication networks. UE 10 is connected to communication network 110 and can communicate with email server 104 via communication network 110, and communication network gateway 106. Network infrastructure 108 may provide a data-centric or dual-mode communications network such as Long Term Evolution (LTE), a Code Division Multiple Access (CDMA) network, a Global System for Mobile Communication (GSM) network, a General Packet Radio Service (GPRS) network, or an Enhanced Data-rates for Global Evolution (EDGE) network. An optional middleware or proxy server 112 may be connected to communication network 110.

In other embodiments, gateway 106 and infrastructure 108 may be deployed inside of communication network 110; and infrastructure 108 and communication network 110 may be deployed inside of Internet 102 (gateway 106 is not required in this deployment scenario); and proxy server 112 may be deployed in either Internet 102 or communication network 110.

Referring to FIG. 1, client computer 100 sends an email via Internet 102 to email server 104. The email is addressed to an email account (e.g., a user identifier (ID) at a particular domain such as bob@example.com) associated with the user of UE 10 and includes a multi-part message that contains both plain text content as well as marked-up content. The email arrives at email server 104 and is stored until retrieved by the email's intended recipient, the user by way of an email client or application on UE 10. In some cases, however, rather than wait for the recipient to ‘pull’ the message from email server 104, email server 104 ‘pushes’ the email to the recipient's device. The email may include one or more file attachments.

Although the present example describes the email as including plain text and alternative HTML-encoded content, it is to be understood that the present system and method can be used during the delivery or receipt of any multi-part email containing multiple content types.

After the delivery of the email to email server 104, UE 10 communicates with email server 104 to retrieve new email. UE 10 may be configured to periodically attempt to retrieve new emails according to a pre-determined polling schedule, or may do so after receiving a request to retrieve new email directly from the user via a user interface of UE 10. If new emails are available on email server 104, UE 10 connects to email server 104 via communication network 110 and Internet 102 to retrieve the messages.

When UE 10 retrieves email messages from email server 104, the present system and method provides for minimizing the amount of data communicated between email server 104 and UE 10 via communication network 110 to improve the performance of the communication network (e.g., by increasing a number of UEs that can communicate via the network and/or minimizing the latency of communication network 110) and to allow UE 10 to display the marked-up content of the email. In some cases, if, for example, the content includes audio content or other content that would be communicated to a user (or another electronic device) by a mechanism other than the display screen of the UE, the UE may be configured to instead present the content to the user using any appropriate content output mechanisms (e.g., audio speakers, vibration devices inside the UE, or other output, or sending a message to another electronic device).

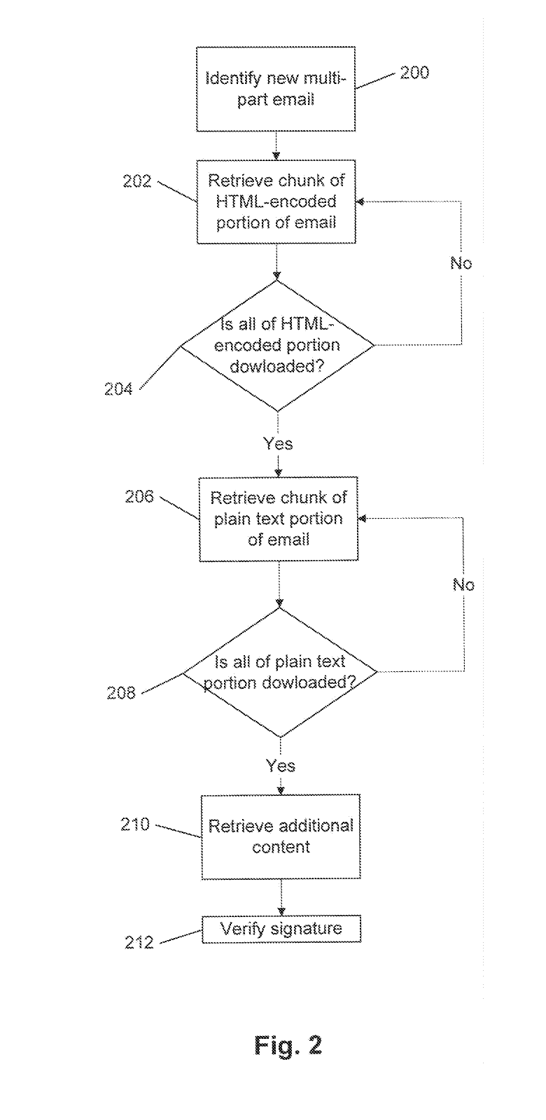

In the present method and system, if both email server 104 and UE 10 support marked-up email content (e.g., HTML-encoded content), email server 104 is configured to first forward the marked-up portion of the email to UE 10. Because UE 10 would simply discard the plain text portion of the email message (or, at least, not display the plain text portion of the email), it would be inefficient to transmit the plain text portion before the marked-up portion. By transmitting only the HTML-encoded portion, the amount of information communicated to UE 10 before the email can be displayed is minimized. In one implementation, the email is transmitted from email server 104 to UE 10 using the method illustrated in FIG. 2 and described below.

Although the transmission of only a portion of the email message allows for less data communication between email server 104 and UE 10, there are some circumstances where the entire content of the email (including both the plain text and marked-up portions) are to be transmitted to the UE. For example, when an email message is digitally signed, the entire content of the email message should be sent to the recipient UE before the signature can be authenticated. Accordingly, in the present system UE 10 may implement the method of FIG. 2 to receive and display a marked-up portion of an email while also being able to verify a digital signature encoded within the email.

FIG. 2 illustrates an example method for a UE to efficiently receive content of an email from an email server, while also being able to verify a digital signature encoded within that email. In the method illustrated in FIG. 2, the UE makes the determination of whether to initially retrieve the HTML-encoded portion of the email or the plain text portion.

In block 200, UE 10 identifies a new email to be retrieved from email server 104. UE 10 may receive a new email notification from email server 104, or may contact email server 104 directly to query whether any new emails are stored on email server 104. In addition to identifying the new email, UE 10 learns that the email message is a multipart email message which includes both a plain text portion and an HTML-encoded portion (although, as mentioned above, the HTML-encoded portion of the email may include other, alternative, encodings).

If UE 10 supports the display of HTML-encoded email content and the user's preferences specify that, if present, the HTML-encoded portion of an email should be displayed, UE 10 first requests the HTML-encoded portion of the new email from email server 104 in block 202. This may be performed by including in the request to download the email content an offset that instructs email server 104 to begin transmitting the email to UE 10 starting at the HTML-encoded portion. In that case, the offset identifies a starting location of the HTML-encoded content within the email's content.

The content of the email is generally retrieved in data chunks, so in block 202, UE 10 requests a first portion or chunk of the HTML-encoded email content. After the first chunk is received, in block 204 UE 10 checks to see whether UE 10 has received all of the HTML-encoded portion of the email. If not, UE 10 requests the next chunk of the HTML-encoded portion of the email, possibly by using a different offset value. This continues until UE 10 has retrieved the entire HTML-encoded portion of the email from email server 104.

As UE 10 begins receiving the HTML-encoded portion of the email (after performing the operation of block 202 for the first time), UE 10 can display the received portions of the HTML-encoded content of the email for a user. As additional chunks of HTML-encoded content are received (by repeating the operation of block 202), the additional content can be used to supplement the display for the user.

After block 204, UE 10 has received all HTML-encoded content of the email and can display it for the user (though portions of the HTML-encoded content may be displayed earlier during the execution of block 202). At this point, however, if the email includes a digital signature, UE 10 is unable to verify the signature because verification requires access to the entire content of the email, including any plain text content.

Accordingly, after retrieving the marked-up portion of the email, UE 10 begins retrieving the remainder of the email message. In the present example, retrieval of the remainder of the email message entails that the UE 10 begin retrieving the plain text portions of the email. Again, this is done in chunks and may be achieved by UE 10 including an appropriate offset identifying the location of plain text content in any request sent to the server. In block 206, therefore, UE 10 requests the first chunk of the email's plain text content. In block 208, UE 10 checks whether all of the plain text content has been retrieved. If not, UE 10 requests an additional chunk of the plain text content. This continues until all of the plain text content has been received by UE 10 from email server 104. Although it takes time to retrieve the plain text content, because the HTML-encoded content has already been retrieved upon the completion of block 204, that portion of the email can be displayed earlier, and the user can begin viewing the email even while the plain text content is retrieved via the communication network.

After receiving the plain text content, UE 10 can stitch or otherwise reassemble or combine the HTML-encoded content and plain text content back together as they would have originally been ordered for verifying any included digital signature. The marked-up and plain text portions of the email should be stitched together correctly (e.g., in a correct order, or with correct spacing between each portion) to ensure that verification of the digital signature does not fail.

If the email message contains any additional content (e.g., additional content having different content-types, etc.), UE 10 can retrieve that content in block 210.

After retrieving the entire contents of the email, UE 10 verifies any included digital signature in block 212.

In an alternative implementation, email server 104 rather than UE 10 determines which portion of the email is initially transmitted to UE 10 after receiving a request from UE 10 to download an email. For example, when email server 104 receives a request from UE 10 to download an email, email server 104 may first determine whether UE 10 is configured to handle HTML-encoded content. If UE 10 is capable of displaying the alternative content and the email includes HTML-encoded content, email server 104 may unilaterally elect to transmit the HTML-encoded portion of the email to UE 10 first, before the plaint text encoded portion. Accordingly, when forwarding the email to UE 10, email server 104 may skip to the HTML-encoded portion of the email using an offset in order to send the HTML content to UE 10 first. In this implementation, email server 104 stores a record or pointer that identifies which portions of the email have been forwarded to UE 10 so that at a later time the plain text content may be forwarded to UE 10.

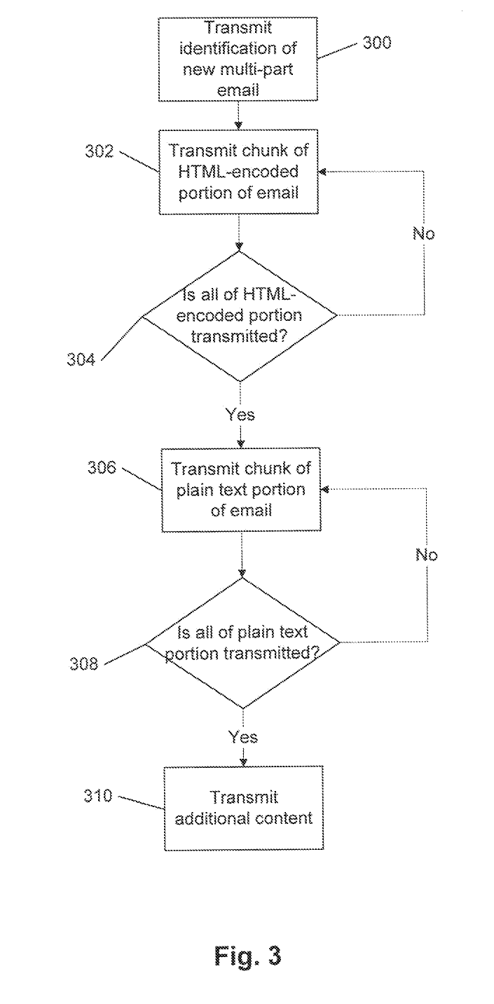

As an example of this implementation, FIG. 3 is an illustration of an alternative example method for an email server to deliver content of an email to a UE, while also allowing the UE to verify a digital signature encoded within that email. In block 300, the email server informs the UE that a new email message is available for retrieval by the UE. In this block, the server may optionally inform the UE that the email message is a multi-part message including both plain text and marked-up text, however it is not necessary that the UE know the email message is multi-part.

In block 302, if UE 10 supports the display of HTML-encoded email content and the user's preferences specify that, if present, the HTML-encoded portion of an email should be displayed, the email server transmits a first chunk of the HTML-encoded portion of the new email to the UE. At this time, the server may store a record indicating the UE has only begun receiving the marked-up portion of the email and has received none of the plain text content. To identify the HTML-encoded portion of the email, the server may use, for example, an offset, where the offset identifies a location of the HTML-encoded content within the email.

After the first chunk is transmitted, the server checks to see whether the UE has received all of the HTML-encoded portion of the email in block 304. If not, the server transmits the next chunk of the HTML-encoded portion of the email to the UE, possibly by using a different offset value. This continues until the UE has retrieved the entire HTML-encoded portion of the email from the server.

As UE 10 begins receiving the HTML-encoded portion of the email (after the server performs the operation of block 302 for the first time), UE 10 can display the received portions of the HTML-encoded content of the email for a user. As additional chunks of HTML-encoded content are transmitted to the UE (by repeating block 302), the additional content can be used to supplement the display for the user.

After block 304, the server has transmitted all HTML-encoded content of the email to the UE. At this point, however, if the email includes a digital signature, the UE is unable to verify the signature since verification requires access to the entire content of the email, including any plain text content.

Accordingly, after transmitting the marked-up portion of the email, the server begins transmitting the remainder of the email message. In the present example, that requires the server to begin transmitting the plain text portions of the email. Again, this is done in chunks. In block 306, the server transmits the first chunk of the email's plain text content. In block 308, the server checks whether all of the plain text content has been retrieved. If not, the server transmits an additional chunk to the UE. This continues until all of the plain text content has been transmitted to the UE. Although it takes time to transmit the plain text content, because the HTML-encoded content has already been transmitted upon the completion of block 304, that portion of the email can be displayed, and the user can begin reviewing the email even while the plain text content is retrieved via the communication network.

After transmitting the plain text content to the UE, the UE can stitch, reassemble or combine the HTML-encoded content and plain text content back together as they would have originally been ordered within the email for the purpose of verifying any included digital signature. The marked-up and plain text portion of the email should be stitched together correctly (e.g., in a correct order, or with correct spacing between each portion) to ensure that verification the digital signature does not fail.

If the email message contains any additional content (e.g., additional content having different content-types, etc.), the server transmits that content to the UE in block 310.

In an alternative implementation of the present system, a middleware or proxy server (see example server 112 on FIG. 1) is connected to communication network 110 and may be configured to send and receive email via Internet 102 on behalf of UE 10.

To use server 112, the user of UE 10 first provides server 112 with account information allowing server 112 to access the user's email account on email server 104. By setting up the account information on server 112, server 112 has the information necessary to retrieve email messages addressed to the user of UE 10 from email server 104 on behalf of UE 10. After retrieving the emails, server 112 can transmit or forward the emails to UE 10.

Accordingly, server 112 may retrieve an email from email server 104 on behalf of a UE 10, and then deliver the email to UE 10 in accordance with the example method illustrated in FIG. 2 or 3.

Alternatively, UE 10 may still be configured to communicate directly with email server 104 to retrieve emails in accordance with the present disclosure, but using server 112 or another component of communication network 110 as a proxy. In that case, server 112 can intercept the email content transmission from email server 104 to UE 10 to re-arrange the contents of the email as the content is delivered to UE 10.

For example, UE 10 may initially attempt to download the email from email server 104 in the email's conventional ordering (e.g., plain text first, followed by marked-up or encoded text). But server 112 can intercept the email's content as it is being transmitted to the UE through server 112, cache the plain text portion of the email, and wait for the encoded or marked-up portion to be transmitted by email server 104. As the encoded or marked-up portion is transmitted by email server 104 to server 112 (for proxying to UE 10), that content is then allowed to be passed through server 112 to UE 10. As such, UE 10 receives the encoded or marked-up content first and can then display the encoded or marked-up content for the user. After the encoded or marked-up content is passed to UE 10 by server 112, server 112 can retrieve the plain text portion from the cache and send that portion of the email to UE 10. UE 10 can then stitch the plain text and encoded or marked-up portions together for authenticating any included digital signature.

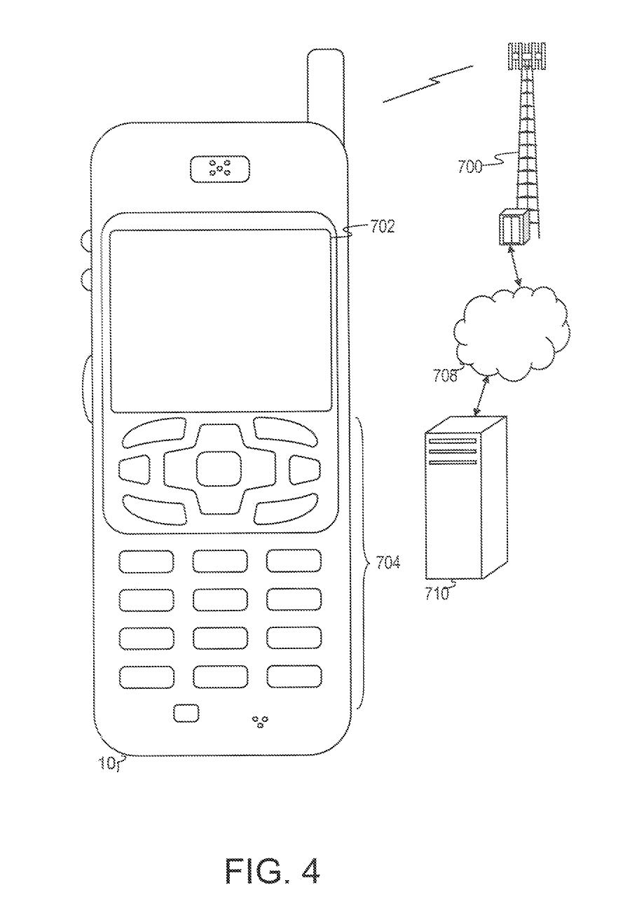

FIG. 4 illustrates an example network communication system including an embodiment of UE 10. UE 10 is operable for implementing aspects of the disclosure, but the disclosure should not be limited to these implementations. Though illustrated as a mobile phone, the UE 10 may take various forms including a wireless handset, a pager, a personal digital assistant (PDA), a portable computer, a tablet computer, a desk phone, a laptop computer. Many suitable devices combine some or all of these functions. In some embodiments of the disclosure, the UE 10 is not a general purpose computing device like a portable, laptop or tablet computer, but rather is a special-purpose communications device such as a mobile phone, a wireless handset, a pager, a PDA, or a telecommunications device installed in a vehicle. The UE 10 may also be a device, include a device, or be included in a device that has similar capabilities but that is not transportable, such as a desktop computer, a set-top box, or a network node. The UE 10 may support specialized activities such as gaming, inventory control, job control, and/or task management functions, and so on.

The UE 10 includes a display 702. The UE 10 also includes a touch-sensitive surface, a keyboard or other input keys generally referred as 704 for input by a user. The keyboard may be a full or reduced alphanumeric keyboard such as QWERTY, Dvorak, AZERTY, and sequential types, or a traditional numeric keypad with alphabet letters associated with a telephone keypad. The input keys may include a trackwheel, an exit or escape key, a trackball, and other navigational or functional keys, which may be inwardly depressed to provide further input function. The UE 10 may present options for the user to select, controls for the user to actuate, and/or cursors or other indicators for the user to direct.

The UE 10 may further accept data entry from the user, including numbers to dial or various parameter values for configuring the operation of the UE 10. The UE 10 may further execute one or more software or firmware applications in response to user commands. These applications may configure the UE 10 to perform various customized functions in response to user interaction. Additionally, the UE 10 may be programmed and/or configured over-the-air, for example from a wireless base station, a wireless access point, or a peer UE 10.

Among the various applications executable by the UE 10 are a web browser, which enables the display 702 to show a web page. The web page may be obtained via wireless communications with a wireless network access node, a cell tower, a peer UE 10, or any other wireless communication network or system 700. The network 700 is coupled to a wired network 708, such as the Internet. Via the wireless link and the wired network, the UE 10 has access to information on various servers, such as a server 710. The server 710 may provide content that may be shown on the display 702. Alternately, the UE 10 may access the network 700 through a peer UE 10 acting as an intermediary, in a relay type or hop type of connection.

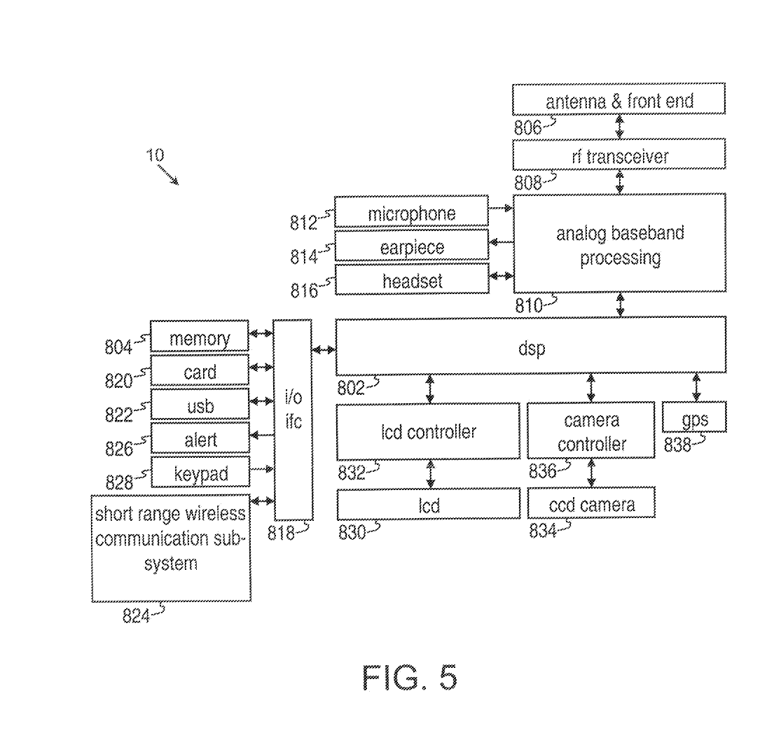

FIG. 5 shows an example block diagram of the UE 10. While a variety of known components of UEs 110 are depicted, in an embodiment a subset of the listed components and/or additional components not listed may be included in the UE 10. The UE 10 includes a digital signal processor (DSP) 802 and a memory 804. As shown, the UE 10 may further include an antenna and front end unit 806, a radio frequency (RF) transceiver 808, an analog baseband processing unit 810, a microphone 812, an earpiece speaker 814, a headset port 816, an input/output interface 818, a removable memory card 820, a universal serial bus (USB) port 822, a short range wireless communication sub-system 824, an alert 826, a keypad 828, a liquid crystal display (LCD), which may include a touch sensitive surface 830, an LCD controller 832, a charge-coupled device (CCD) camera 834, a camera controller 836, and a global positioning system (GPS) sensor 838. In an embodiment, the UE 10 may include another kind of display that does not provide a touch sensitive screen. In an embodiment, the DSP 802 may communicate directly with the memory 804 without passing through the input/output interface 818.

The DSP 802 or some other form of controller or central processing unit operates to control the various components of the UE 10 in accordance with embedded software or firmware stored in memory 804 or stored in memory contained within the DSP 802 itself. In addition to the embedded software or firmware, the DSP 802 may execute other applications stored in the memory 804 or made available via information carrier media such as portable data storage media like the removable memory card 820 or via wired or wireless network communications. The application software may comprise a compiled set of machine-readable instructions that configure the DSP 802 to provide the desired functionality, or the application software may be high-level software instructions to be processed by an interpreter or compiler to indirectly configure the DSP 802.

The antenna and front end unit 806 may be provided to convert between wireless signals and electrical signals, enabling the UE 10 to send and receive information from a cellular network or some other available wireless communications network or from a peer UE 10. In an embodiment, the antenna and front end unit 806 may include multiple antennas to support beam forming and/or multiple input multiple output (MIMO) operations. As is known to those skilled in the art, MIMO operations may provide spatial diversity which can be used to overcome difficult channel conditions and/or increase channel throughput. The antenna and front end unit 806 may include antenna tuning and/or impedance matching components, RF power amplifiers, and/or low noise amplifiers.

The RF transceiver 808 provides frequency shifting, converting received RF signals to baseband and converting baseband transmit signals to RF. In some descriptions a radio transceiver or RF transceiver may be understood to include other signal processing functionality such as modulation/demodulation, coding/decoding, interleaving/deinterleaving, spreading/despreading, inverse fast Fourier transforming (IFFT)/fast Fourier transforming (FFT), cyclic prefix appending/removal, and other signal processing functions. For the purposes of clarity, the description here separates the description of this signal processing from the RF and/or radio stage and conceptually allocates that signal processing to the analog baseband processing unit 810 and/or the DSP 802 or other central processing unit. In some embodiments, the RF Transceiver 808, portions of the Antenna and Front End 806, and the analog base band processing unit 810 may be combined in one or more processing units and/or application specific integrated circuits (ASICs).

The analog base band processing unit 810 may provide various analog processing of inputs and outputs, for example analog processing of inputs from the microphone 812 and the headset 816 and outputs to the earpiece 814 and the headset 816. To that end, the analog base band processing unit 810 may have ports for connecting to the built-in microphone 812 and the earpiece speaker 814 that enable the UE 10 to be used as a cell phone. The analog base band processing unit 810 may further include a port for connecting to a headset or other hands-free microphone and speaker configuration. The analog base band processing unit 810 may provide digital-to-analog conversion in one signal direction and analog-to-digital conversion in the opposing signal direction. In some embodiments, at least some of the functionality of the analog base band processing unit 810 may be provided by digital processing components, for example by the DSP 802 or by other central processing units.

The DSP 802 may perform modulation/demodulation, coding/decoding, interleaving/deinterleaving, spreading/despreading, inverse fast Fourier transforming (IFFT)/fast Fourier transforming (FFT), cyclic prefix appending/removal, and other signal processing functions associated with wireless communications. In an embodiment, for example in a code division multiple access (CDMA) technology application, for a transmitter function the DSP 802 may perform modulation, coding, interleaving, and spreading, and for a receiver function the DSP 802 may perform despreading, deinterleaving, decoding, and demodulation. In another embodiment, for example in an orthogonal frequency division multiplex access (OFDMA) technology application, for the transmitter function the DSP 802 may perform modulation, coding, interleaving, inverse fast Fourier transforming, and cyclic prefix appending, and for a receiver function the DSP 802 may perform cyclic prefix removal, fast Fourier transforming, deinterleaving, decoding, and demodulation. In other wireless technology applications, yet other signal processing functions and combinations of signal processing functions may be performed by the DSP 802.

The DSP 802 may communicate with a wireless network via the analog baseband processing unit 810. In some embodiments, the communication may provide Internet connectivity, enabling a user to gain access to content on the Internet and to send and receive e-mail or text messages. The input/output interface 818 interconnects the DSP 802 and various memories and interfaces. The memory 804 and the removable memory card 820 may provide software and data to configure the operation of the DSP 802. Among the interfaces may be the USB interface 822 and the short range wireless communication sub-system 824. The USB interface 822 may be used to charge the UE 10 and may also enable the UE 10 to function as a peripheral device to exchange information with a personal computer or other computer system. The short range wireless communication sub-system 824 may include an infrared port, a Bluetooth interface, an IEEE 802.11 compliant wireless interface, or any other short range wireless communication sub-system, which may enable the UE 10 to communicate wirelessly with other nearby mobile devices and/or wireless base stations.

The input/output interface 818 may further connect the DSP 802 to the alert 826 that, when triggered, causes the UE 10 to provide a notice to the user, for example, by ringing, playing a melody, or vibrating. The alert 826 may serve as a mechanism for alerting the user to any of various events such as an incoming call, a new text message, and an appointment reminder by silently vibrating, or by playing a specific pre-assigned melody for a particular caller.

The keypad 828 couples to the DSP 802 via the interface 818 to provide one mechanism for the user to make selections, enter information, and otherwise provide input to the UE 10. The keyboard 828 may be a full or reduced alphanumeric keyboard such as QWERTY, Dvorak, AZERTY and sequential types, or a traditional numeric keypad with alphabet letters associated with a telephone keypad. The input keys may include a trackwheel, an exit or escape key, a trackball, and other navigational or functional keys, which may be inwardly depressed to provide further input function. Another input mechanism may be the LCD 830, which may include touch screen capability and also display text and/or graphics to the user. The LCD controller 832 couples the DSP 802 to the LCD 830.

The CCD camera 834, if equipped, enables the UE 10 to take digital pictures. The DSP 802 communicates with the CCD camera 834 via the camera controller 836. In another embodiment, a camera operating according to a technology other than Charge Coupled Device cameras may be employed. The GPS sensor 838 is coupled to the DSP 802 to decode global positioning system signals, thereby enabling the UE 10 to determine its position. Various other peripherals may also be included to provide additional functions, e.g., radio and television reception.

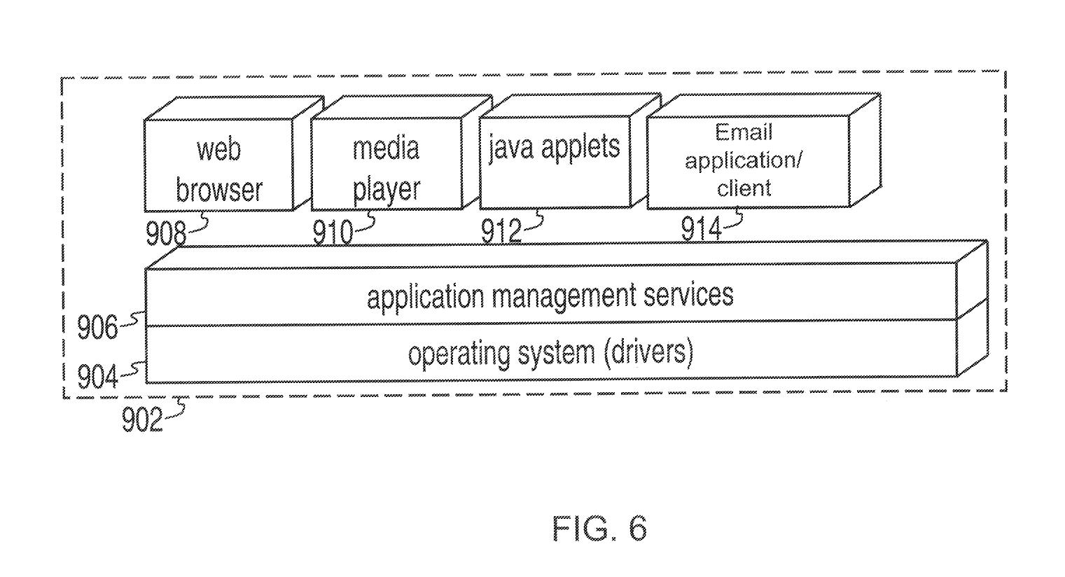

FIG. 6 illustrates an example software environment 902 that may be implemented by the DSP 802. The DSP 802 executes operating system drivers 904 that provide a platform from which the rest of the software operates. The operating system drivers 904 provide drivers for the UE hardware with standardized interfaces that are accessible to application software. The operating system drivers 904 include application management services (“AMS”) 906 that transfer control between applications running on the UE 10. Also shown in FIG. 6 are a web browser application 908, a media player application 910, and Java applets 912. The web browser application 908 configures the UE 10 to operate as a web browser, allowing a user to enter information into forms and select links to retrieve and view web pages. The media player application 910 configures the UE 10 to retrieve and play audio or audiovisual media. The Java applets 912 configure the UE 10 to provide games, utilities, and other functionality. In some implementations, an email client or application 914 might provide functionality described herein.

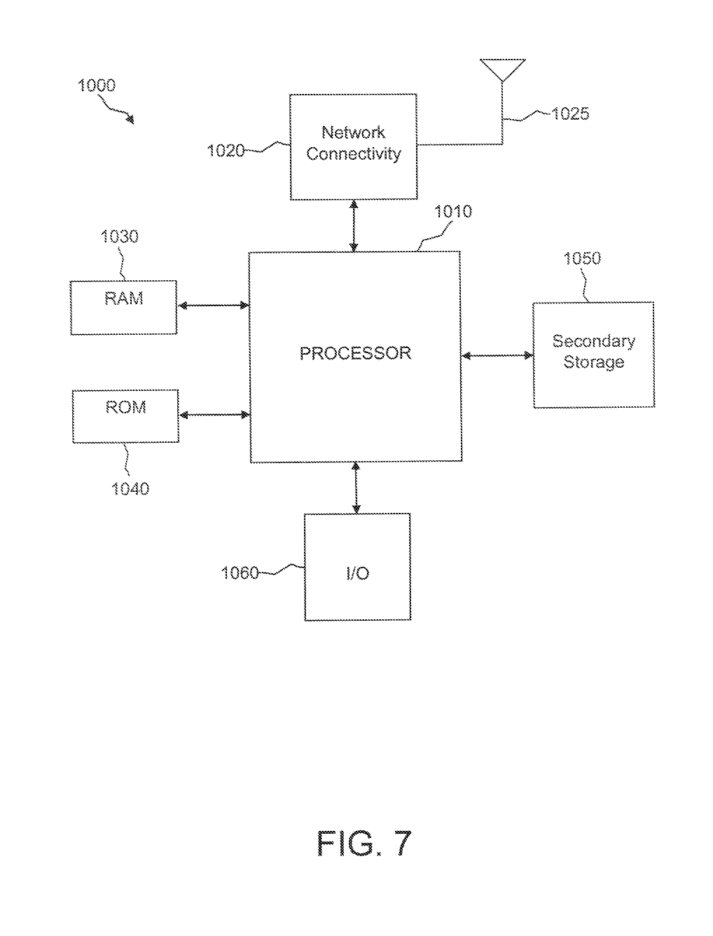

The UE 10, and other components described above might include a processing component that is capable of executing instructions related to the actions described above. FIG. 7 illustrates an example of a system or apparatus 1000 that includes a processing component 1010 suitable for implementing one or more embodiments disclosed herein. In addition to the processor 1010 (which may be referred to as a central processor unit (CPU or DSP), the system 1000 might include network connectivity devices 1020, random access memory (RAM) 1030, read only memory (ROM) 1040, secondary storage 1050, and input/output (I/O) devices 1060. In some cases, some of these components may not be present or may be combined in various combinations with one another or with other components not shown. These components might be located in a single physical entity or in more than one physical entity. Any actions described herein as being taken by the processor 1010 might be taken by the processor 1010 alone or by the processor 1010 in conjunction with one or more components shown or not shown in the drawing.

The processor 1010 executes instructions, codes, computer programs, or scripts that it might access from the network connectivity devices 1020, RAM 1030, ROM 1040, or secondary storage 1050 (which might include various disk-based systems such as hard disk, floppy disk, or optical disk). While only one processor 1010 is shown, multiple processors may be present. Thus, while instructions may be discussed as being executed by a processor, the instructions may be executed simultaneously, serially, or otherwise by one or multiple processors. The processor 1010 may be implemented as one or more CPU chips.

The network connectivity devices 1020 may take the form of modems, modem banks, Ethernet devices, universal serial bus (USB) interface devices, serial interfaces, token ring devices, fiber distributed data interface (FDDI) devices, wireless local area network (WLAN) devices, radio transceiver devices such as code division multiple access (CDMA) devices, global system for mobile communications (GSM) radio transceiver devices, worldwide interoperability for microwave access (WiMAX) devices, and/or other well-known devices for connecting to networks. These network connectivity devices 1020 may enable the processor 1010 to communicate with the Internet or one or more telecommunications networks or other networks from which the processor 1010 might receive information or to which the processor 1010 might output information.

The network connectivity devices 1020 might also include one or more transceiver components 1025 capable of transmitting and/or receiving data wirelessly in the form of electromagnetic waves, such as radio frequency signals or microwave frequency signals. Alternatively, the data may propagate in or on the surface of electrical conductors, in coaxial cables, in waveguides, in optical media such as optical fiber, or in other media. The transceiver component 1025 might include separate receiving and transmitting units or a single transceiver. Information transmitted or received by the transceiver 1025 may include data that has been processed by the processor 1010 or instructions that are to be executed by processor 1010. Such information may be received from and outputted to a network in the form, for example, of a computer data baseband signal or signal embodied in a carrier wave. The data may be ordered according to different sequences as may be desirable for either processing or generating the data or transmitting or receiving the data. The baseband signal, the signal embedded in the carrier wave, or other types of signals currently used or hereafter developed may be referred to as the transmission medium and may be generated according to several methods well known to one skilled in the art.

The RAM 1030 might be used to store volatile data and perhaps to store instructions that are executed by the processor 1010. The ROM 1040 is a non-volatile memory device that typically has a smaller memory capacity than the memory capacity of the secondary storage 1050. ROM 1040 might be used to store instructions and perhaps data that are read during execution of the instructions. Access to both RAM 1030 and ROM 1040 is typically faster than to secondary storage 1050. The secondary storage 1050 is typically comprised of one or more disk drives or tape drives and might be used for non-volatile storage of data or as an over-flow data storage device if RAM 1030 is not large enough to hold all working data. Secondary storage 1050 may be used to store programs that are loaded into RAM 1030 when such programs are selected for execution.

The I/O devices 1060 may include liquid crystal displays (LCDs), touch screen displays, keyboards, keypads, switches, dials, mice, track balls, voice recognizers, card readers, paper tape readers, printers, video monitors, or other well-known input/output devices. Also, the transceiver 1025 might be considered to be a component of the I/O devices 1060 instead of or in addition to being a component of the network connectivity devices 1020. Some or all of the I/O devices 1060 may be substantially similar to various components depicted in the previously described drawing of the UE 10, such as the display 702 and the input 704.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component, whether electrically, mechanically, or otherwise. Other examples of changes, substitutions, and alterations are ascertainable by one skilled in the art and may be made without departing from the spirit and scope disclosed herein.

To apprise the public of the scope of this invention, the following claims are made:

What is claimed is:

1. A method of receiving an email message using a communication network, comprising:
identifying an email message to be retrieved from a server, the email message being a multi-part message and including content having two or more content types;
determining a first content type to be retrieved from the server, the first content type including non-plain-text content;
retrieving content of the email message having the first content type from the server using the communication network;
presenting the content having the first content type;
after retrieving the content having the first content type from the server, retrieving content of the email message having a second content type from the server; and
verifying a digital signature associated with the email message.

2. The method of claim 1, wherein retrieving the content of the email message having the first content type from the server includes transmitting an offset to the server, the offset identifying a location of the content of the email message having the first content type within the email message.

3. The method of claim 1, wherein retrieving the content of the email message having the first content type from the server includes receiving a plurality of data chunks from the server, each of the plurality of data chunks including at least a portion of the content of the email message having the first content type of the email message.

4. The method of claim 1, wherein the digital signature is at least one of a Secure/Multipurpose Internet Mail Extensions (S/MIME) and Pretty Good Privacy (PGP) signature.

5. The method of claim 1, wherein the first content type includes hyper-text markup language (HTML) encoded content, and the second content type includes plain text encoded content.

6. A method for transmitting an email message using a communication network, comprising:
identifying an email message to be transmitted to a user equipment, the email message including content having two or more content types;
determining whether the user equipment is configured to display a first content type; and
when the user equipment is configured to display the first content type:
transmitting content of the email message having the first content type to the user equipment, and
after transmitting the content of the email message having the first content type to the user equipment, transmitting content of the email message having a second content type to the user equipment.

7. The method of claim 6, including using an offset to identify a location of the content of the email message having the first content type.

8. The method of claim 6, wherein transmitting content of the email message having the first content type to the user equipment includes transmitting a plurality of data chunks to the user equipment, each of the plurality of data chunks including at least a portion of the content of the email message having the first content type.

9. The method of claim 6, including transmitting a digital signature to the user equipment, the digital signature being associated with the email message.

10. The method of claim 9, wherein the digital signature is at least one of a Secure/Multipurpose Internet Mail Extensions (S/MIME) and Pretty Good Privacy (PGP) signature.

11. The method of claim 6, wherein the first content type includes hyper-text markup language (HTML) encoded content.

12. A user equipment for receiving an email message using a communication network, comprising:
a processor, the processor being configured to:
identify an email message to be retrieved from a server, the email message being a multi-part message and including content having two or more content types;
determine a first content type to be retrieved from the server, the first content type including non-plain-text content;
retrieve content of the email message having the first content type from the server using the communication network;
present the content having the first content type;
after retrieving the content having the first content type from the server, retrieve content of the email message having a second content type from the server; and
verify a digital signature associated with the email message.

13. The user equipment of claim 12, wherein the processor is configured to transmit an offset to the server, the offset identifying a location of the content of the email message having the first content type within the email message.

14. The user equipment of claim 12, wherein the processor is configured to receive a plurality of data chunks from the server, each of the plurality of data chunks including at least a portion of the content of the email message having the first content type of the email message.

15. The user equipment of claim 12, wherein the digital signature is at least one of a Secure/Multipurpose Internet Mail Extensions (S/MIME) and Pretty Good Privacy (PGP) signature.

16. The user equipment of claim 12, wherein the first content type includes hyper-text markup language (HTML) encoded content, and the second content type includes plain text encoded content.

17. A network component for transmitting an email message using a communication network, comprising:
a processor, the processor being configured to:
identify an email message to be transmitted to a user equipment, the email message including content having two or more content types;
determine whether the user equipment is configured to display a first content type; and
when the user equipment is configured to display the first content type:
transmit content of the email message having the first content type to the user equipment, and
after transmitting the content of the email message having the first content type to the user equipment, transmit content of the email message having a second content type to the user equipment.

18. The network component of claim 17, wherein the processor is configured to use an offset to identify a location of the content of the email message having the first content type.

19. The network component of claim 17, wherein the processor is configured to transmit a plurality of data chunks to the user equipment, each of the plurality of data chunks including at least a portion of the content of the email message having the first content type.

20. The network component of claim 17, wherein the processor is configured to transmit a digital signature to the user equipment, the digital signature being associated with the email message.

21. The network component of claim 20, wherein the digital signature is at least one of a Secure/Multipurpose Internet Mail Extensions (S/MIME) and Pretty Good Privacy (PGP) signature.

22. The network component of claim 17, wherein the first content type includes hyper-text markup language (HTML) encoded content.
